(19) United States
(12) Patent Application Publication
(10) Pub. No.: US 2003/0145443 A1
(43) Pub. Date: Aug. 7, 2003

(54) Apparatus for manufacturing one piece molding of corpse bag and hermetic corpse bag manufactured with the same

(76) Inventor: Chin-Chang Lee, Miao Li Hsien (TW)

Correspondence Address: BUCKNAM AND ARCHER, 1077 NORTHERN BOULEVARD, ROSLYN, NY, 11576, US

(21) Appl. No.: 10/066,867

(22) Filed: Feb. 4, 2002

(51) Int. Cl. A61G 1/00

(52) U.S. Cl. 27/28; 156/500; 156/530

(57) ABSTRACT

An apparatus for one piece molding of corpse bag comprises: a bag-blowing device used for blow molding the prototype of the bag; a feed device used for progressively feeding the prototype bag; a slab device placed in the prototype bag and is positioned at a fixed level; a knife device used to cut a U-shaped cut on the bag surface; an adhering device used to seal the U-shaped cut; a sealing and cutting device used to seal and to cut the bag so as to separate the products of bags. The present invention also discloses a kind of hermetic corpse bag made by an apparatus for manufacturing one piece molding of corpse bag.

### FIELD OF THE INVENTION

The present invention relates to the manufacture of hermetic corpse bag. More particularly, it relates to the method of one piece molding with blow molding so as to automatically and rapidly manufacture the hermetic corpse bag at low cost. Moreover, due to the improvement of such a bag structure, it reaches to completely hermetic and, therefore, prevents blood water and stink from running out, and complies with sanitary condition.

### PRIOR ART

The manufacturing course of traditional corpse bag, as shown in FIG. 1 to FIG. 1C, includes:

Step 1 Preparing material and cutting into bottom sheet 10 and top sheet 11 with proper size.

Step 2 Cutting the top sheet 11 along the opening line to separate out an another sheet 11′.

Step 3 Both sides of traditional zipper 12 are respectively connected to fusionable plastic piece 11a, 11a so as to leave a position of seal line (which adheres to bottom plate 10) on the fusionable pieces.

Step 4 Using a sewing machine to sew traditional zipper 12 along the opening line between top sheet 11 and the sheet 11′.

Step 5 Using side sheets 13 to respectively cover the four sides of the top sheet 11 and bottom sheet 10 and then using a sewing machine to form a bag 1 through sewing.

Step 6 Using high frequency sealing method, to seal a seal line 14 along the inner side of sewing line of the four sides of the bag 1.

In the above traditional course of manufacture, after completing step 5, due to sewing the four sides of the bag with sewing thread, hermetic effect is poor. When a corpse is put into the bag, blood water and stink often shed out. Therefore, the industrial manufacture of the bag adds the step 6, i.e. to form a seal line on the inner side of sewing thread of the bag with high frequency sealing unite so as to increase hermetic effect. However, in general, the size of corpse bag is 36″×90″. Due to the maximum stroke of high frequency machine and the range which operator can control, the maximum length which can seal at one time is only 36″. Therefore, it is necessary to perform at least 8 sealing processes to form a corpse bag. It is time-consuming and labor intensive.

However, customarily, after a relative is deceased, the Chinese often temporarily put their deceased relative in corpse bag other than in refrigerator. With the hope that the deceased one may regain consciousness. However, generally after man died for 2 hours, blood water will continuously shed out from mouth, nose or wounds, and even penetrating out thru voids. It is easy to cause bacterial infection. Although the above mentioned traditional corpse bag has hermetic effect, after closing the teeth of zipper, many voids still exist between its teeth (as shown in FIG. 1b, enlarged section). In addition, gas permeability still exists between cloth fibers of the zipper. Therefore, it is a risk that blood water as well as stink might still shed out.

In addition, it is known that a zip bag is characterized by good hermeticity. No one has thought of using it in this field. Although the above drawbacks may be improved by the zip bag instead of traditional zipper, its structure (as shown in FIG. 1d) includes two long base materials 16, 16′. There are rails 17, 17′ (which may be correspondingly fastened) respectively provided on the base materials 16, 16′. After the base materials 16, 16′ separately run thru high and low entry holes of zipper head 15, it penetrates thru the exit hole after the zipper fastened on the same plane. Therefore, the base materials 16, 16′ form a V-shaped opening on the front of the zipper head 15 so that when the zipper head 15 is fastened to the end, it still forms a V-shaped cut and could not attain to the complete sealing state.

### SUMMARY OF THE INVENTION

The main object of this invention is to provide apparatus for manufacturing one piece molding of corpse bag by means of blow molding so as to rapidly mass-manufacture the corpse at low cost. In order to attain the above object and other objects, this apparatus includes a bag-blowing machine used for blow molding the prototype of the bag (reel form) after the fusionable polymer is melted, a feed device, which is used for progressively feeding the prototype bag with predefined length, a slab device in the bag which has many driven rolls on its bottom and is positioned at a fixed level by a positional mechanism, a knife device, which is situated above the prototype bag, opposite to the slab device and is used to cut a U-shaped cut on the bag surface, an adhering device which is behind the knife device and which is used for sealing the U-shaped cut and a sealing and cutting device, which is used to form two seal lines on the fixed position in front of the bag and to cut between these seal lines so as to separate adjacent bags so that this apparatus can continuously and rapidly produce the corpse bags made by one piece molding.

Another object of this invention is to provide the hermetic corpse bags. It attains complete hermeticity thru the improvement of its structure so as to prevent blood water and stink from shedding out.

According to this invention, such corpse bag mainly includes a bag, which is formed by the above mentioned bag-blowing machine, sealing lines which are thermally sealed on both front end and behind end, a cut which is formed on its surface, two hermetic belts which are thermally sealed on the both side edges of the cut, rails which can fasten each other and which are formed on the hermetic belts, a tab which is formed on the end of the cut in the bag and runs thru between the two hermetic belts, correspondingly engaging concave and convex edges are formed on the upper and lower end faces, which edges correspond to the rails of two hermetic belts and a zipper head whose front end forms into a protruding lip, on planes of different height of which high and low entry holes are formed, and whose rear end forms a common exit hole on the same plane. After the above mentioned two hermetic belts respectively enter from the high and low entry holes of the zipper head and fasten on the same plane, it runs thru the exist hole. When the zipper head is pulled to the end, the tab and two hermetic belts engage each other at the lip of zipper head to form a hermetic space.

### BRIEF DESCRIPTION OF ACCOMPANYING DRAWINGS

In order to further understand the above object and other objects, characteristics and efficiency of this invention, explanation are made by embodiments, when taken in conjunction with the accompanying drawings:

FIG. 1-1c is the schematic views of manufacturing process of the corpse bag in prior art, in which FIG. 1c is a sectional view taken along 1c-1c.

FIG. 1d is the structure view of the conventional zipper bag.

FIG. 2-2b are schematic views of manufacturing the bag of this invention, in which, FIG. 2a is a sectional view along 2a-2a.

FIG. 3 is partially enlarged sectional view of a slab device and a positioning mechanism of this invention, in which, a bag is cut open.

FIG. 3a is an enlarged sectional view taken along 3a-3a of FIG. 3.

FIG. 4-4b are perspective views of this invention, in which, FIG. 4a is a sectional view taken along 4a-4a of FIG. 4.

FIG. 5-5a is an another embodiment of the schematic views of manufacturing the bags, in which, FIG. 5a is a sectional view taken along 5a-5a of FIG. 5.

FIG. 6 shows a partially enlarged view of the opening end of the bag of FIG. 5 embodiment, in which hermetic belts have not been fastened yet.

FIG. 6a is a view of improved zipper head of this invention.

FIG. 6b is taken from 6b-6b of FIG. 6, in which hermetic belt has fastened together.

FIG. 7 shows a relation between a protecting piece and hermetic belts of this invention.

FIG. 8 is an another embodiment showing the relation between the protecting piece and hermetic belts.

FIG. 9 is an another embodiment of the opening structure of the bag.

FIG. 9a is an enlarged sectional view taken along 9a-9a of FIG. 9.

FIG. 10 is an another embodiment of the opening structure of the bag.

FIG. 10a is an enlarged sectional view taken along 10a-10a of FIG. 10.

FIG. 11 is an another structural embodiment of improved zipper head of this invention, in which, the opening end of hermetic belts is in non-engaging state.

FIG. 11a is the enlarged front perspective view of the zipper head in FIG. 11.

FIG. 11b is the sectional view taken along 11b-11b of FIG. 11, in which, the hermetic belt is in engaging-state, and the zipper head is shown in dotted lines.

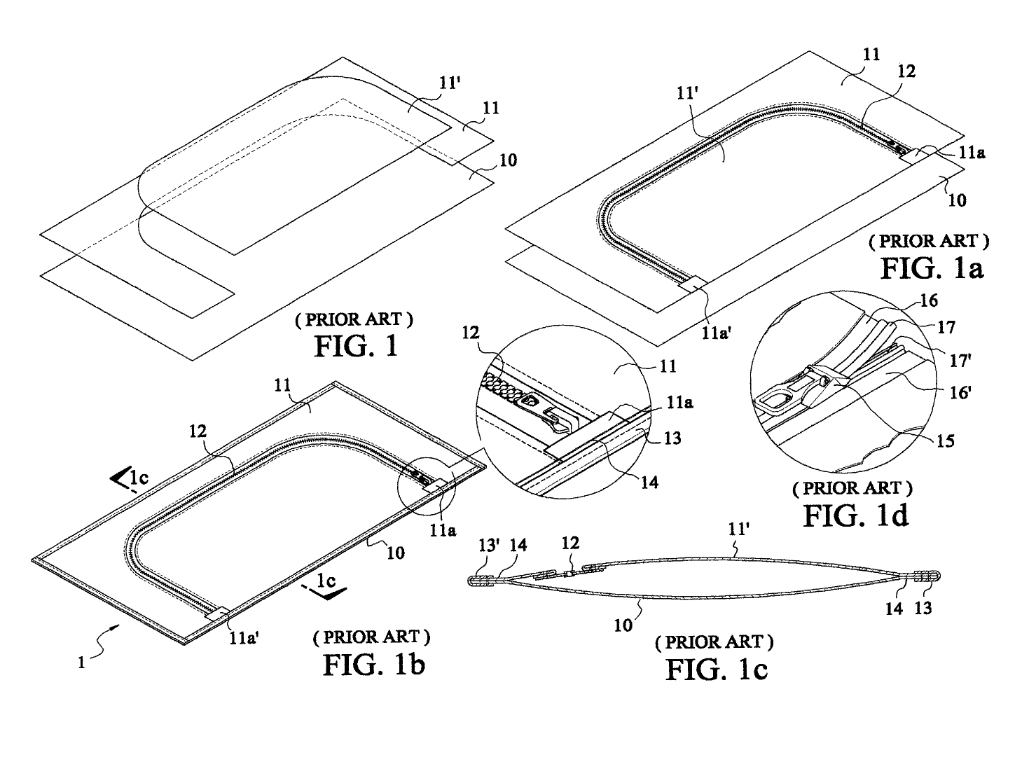

### DETAILED DESCRIPTIONS OF PREFERRED EMBODIMENT

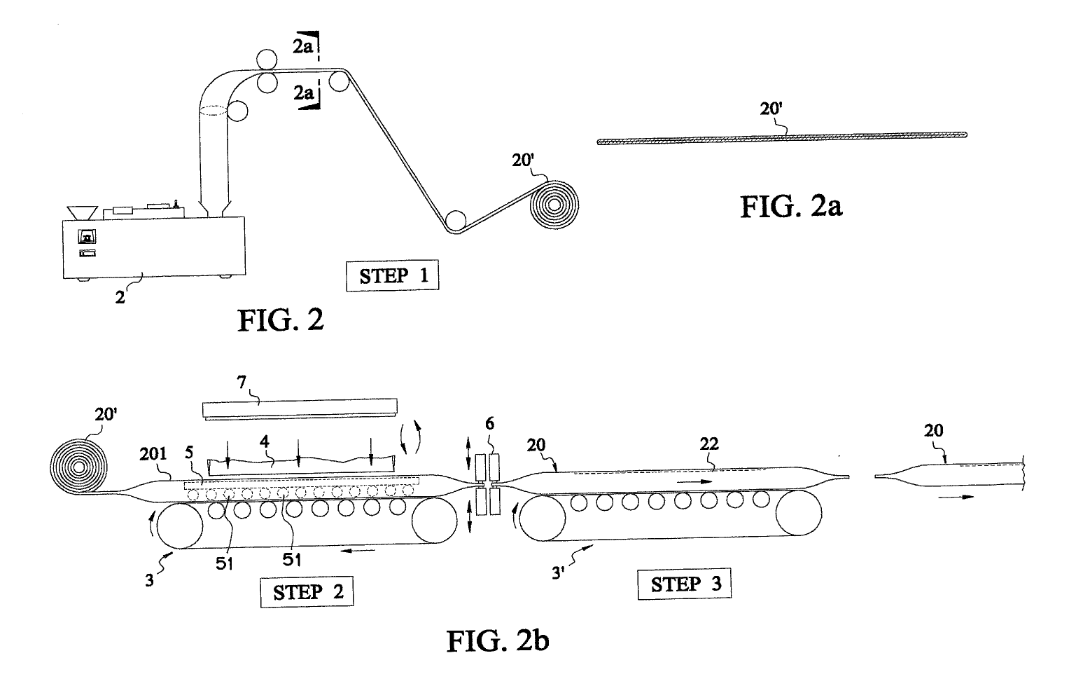

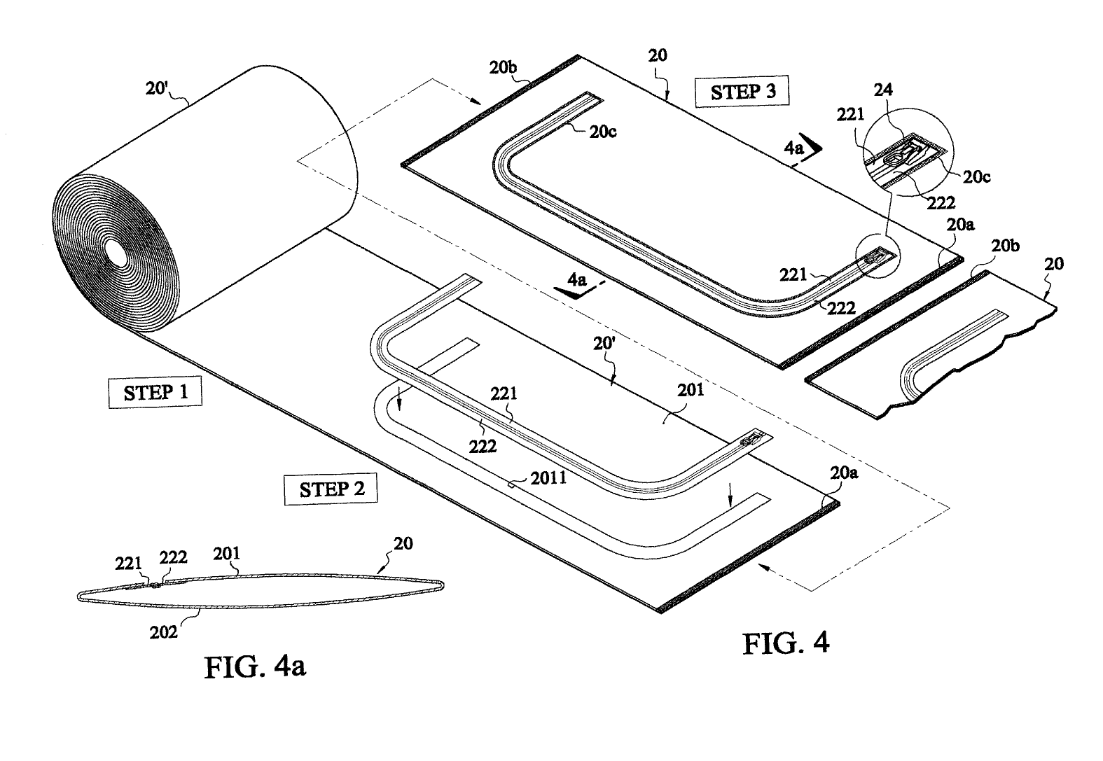

Firstly, referring to FIG. 2-2b with reference to FIG. 4-4a, the apparatus for one piece molding of corpse bag of this invention includes:

Step 1: Environmental protection material or thermofusion polymer, such as PE (polyethylene) is conveyed to the bag blowing machine 2 for blow molding into a continuous pipe-shaped prototype bag 20′ and is reeled such bag 20′ on a conventional reel.

Step 2: A feed device 3 which feeds the prototype bag 20′ with a predetermined length, a slab device 5 which includes a slab 52 having many rolls 51 on its bottom and which is slab device 5 is placed in the prototype bag 20′ and is positioned by positioning mechanism so as not to displace, a knife device 4, which is above the slab device 5 and periodically acts on the bag surface 201 (which is above the slab 52) to form a U-shaped cut 2011. After cutting, the knife device 4 retracts to the original position. An adhering device 7 is above the slab device 5 and behind the knife device 4. It also periodically acts from above to below for alternatively sealing the U-shaped cut 2010, 2011 of bag 20. This adhering device may be a hot press. It forms and adheres together a fusion line 20c and two hermetic belts 221, 222 on the surroundings of U-shaped cut 2011 of bag 20 (as shown in FIG. 4).

Step 3: Finally, a sealing and cutting device 6. This device forms two seal lines 20a, 20b at a given position in front of the bag 20′and cuts between the two seal lines 20a, 20b so as to separate neighboring bags 20. Then the feed device 3′ feeds the prototype bag 20′ to a given position. At the same time, it propels forward the separated bags 20. Thus, one piece molding corpse bags can be produced continuously and rapidly.

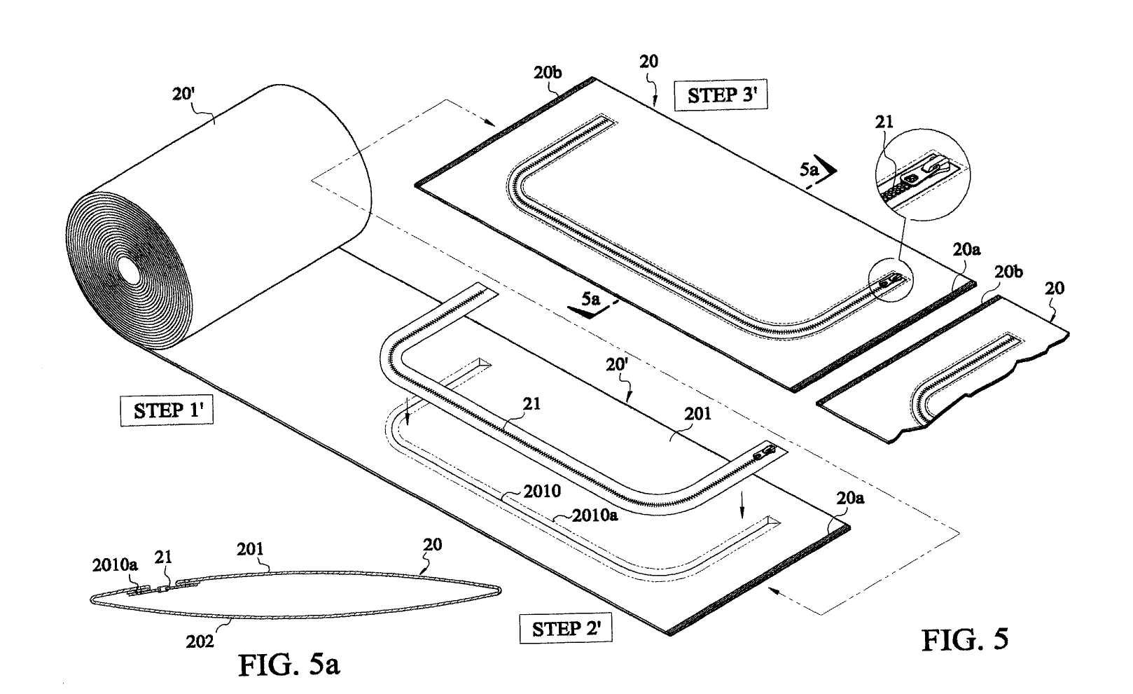

FIG. 5-5a are the another embodiment of this invention. The differences between this embodiment and the above mentioned one is that: the latter embodiment uses hermetic belts 221, 222 as a sealing element while the former one uses traditional zipper 21 as a sealing element. The manufacturing method is substantially the same as above mentioned embodiment. Therefore, no further description is necessary. The only difference is that: in Step 2, knife device 2 only cuts a U-shaped cut 2010 having no width on the surface 201 of prototype bag 20′ so as to pre-keep the folding edge of zipper 21 for sewing (as shown in the imagining line 2010a). After the cut 2010 is made, Step 3 is performed (the same as above mentioned embodiment) to form seal lines 20a, 20b and to separate bags 20. The separated bag 20 is fed to other step. By using conventional sewing machine (not shown), a conventional zipper 21 is sewed on the cut 2010 of U-shaped bag 20 (as shown in FIG. 5) to complete this manufacturing course.

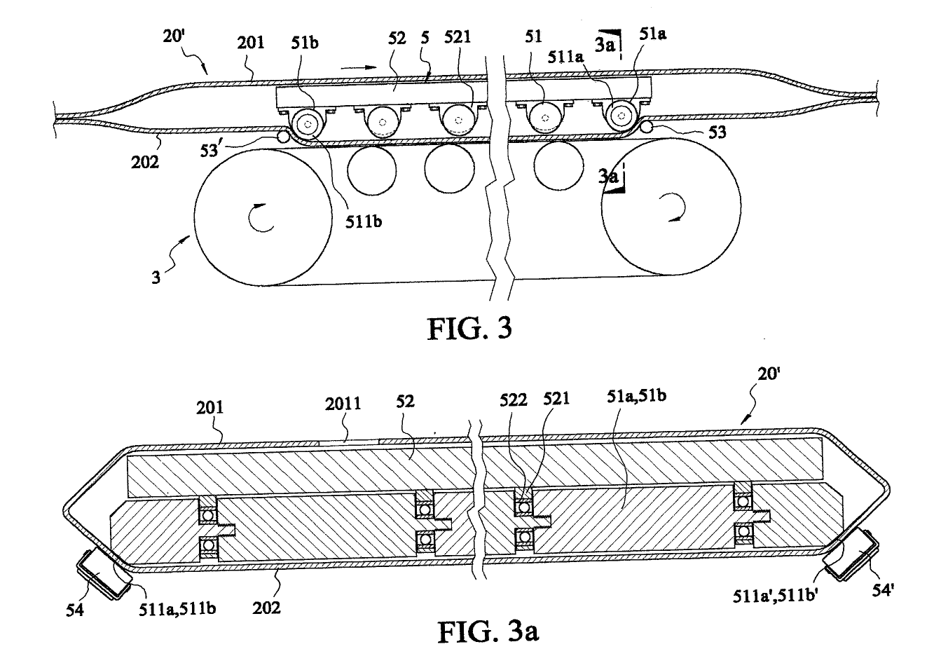

Please refer to FIG. 3-3a again, in accordance with the above mentioned Step 2 of this invention, during the feeding course of prototype bag 20′, in order to keep the slab device 5 at a fixed level, many driven rolls 51 are installed on the bottom of slab device 5 and are positioned by positioning mechanism so as to let rolls 51 be driven in situ without displacement when the prototype bag 20′feeds in. The positioning mechanism includes conflict elements 53, 53′ (corresponding to the initial roll 51a and finishing roll 51b of slab device 5) separately abut against the outside of initial roll 51aand finishing roll 51b, separated by the bottom face 202 of prototype bag 20′ for confining both front and behind levels of slab device 5 (as shown in FIG. 3). Preferably, the conflict elements 53, 53′ are rolls. It may be driven following the feeding of bottom face 202. In addition, conical slopes 511a, 511a′; 511b, 511b′ may be separately formed on both ends of the initial roll 51a and finishing roll 51b of slab device 5. Corresponding to the conical slopes 511a, 511a′; 511b, 511b′, conflict elements 54, 54′ are installed separately, which abut against both ends of initial roll 51a and finishing roll 51b, and are separated by the bottom face 202 of prototype bag 20′ so as to confine the left and right levels of slab device 5 (as shown in FIG. 3a). Preferably, the conflict elements 54, 54′ which are rolling wheels may be driven along with the feeding of bottom 202. In addition, each roll 51 of slab device 5 is situated on the central shaft, separately by many bearing seats 521 (which are situated on the bottom of the slab 52) and bearing 522 so as to convey the impulse force from above knife device 4 to the support below.

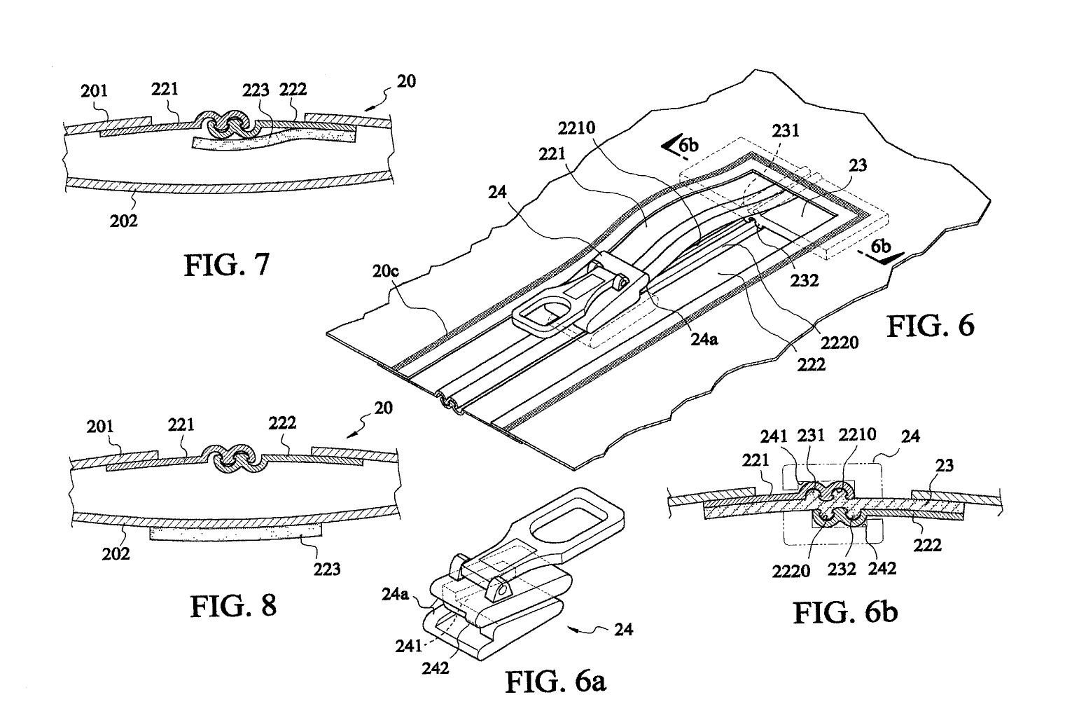

Please refer to FIG. 4 again and FIG. 6-6b, in accordance with the hermetic corpse bag of this invention, it includes a bag body 20 which is produced by bag-blowing machine and has seal lines 20a, 20b on its both ends and a cut 2011 is formed on the surface 201, two hermetic belts 221, 222 which are made of the thermofusion waterproof material, two hermetic belts 221, 222 which are separately fused by means of fusing line 20c, on both sides of the cut 2011, the hermetic belts 221, 222 are provided with rails 2210, 2220 (which can be fastened together), a zipper head 24 (as shown in FIG. 6a) which has a protruding lip 24a on its front end, a high entry hole 241 and a low entry hole 242 which are formed on the planes of different height in lip 24a, and a common exit hole is formed on the same plane at the rear end.

Two hermetic belts 221, 222 run separately thru the entry holes 241, 242. After they are fastened, and then runs out thru the exit hole. Because two hermetic belts 221, 222 (in the form of upper and lower pieces) separately run thru entry holes 241, 242 of the zipper head 24, a V-shaped opening is formed at the front end of zipper head 24 (as shown in FIG. 6). In order not to form an incomplete seal at the end when the zipper head 24 is pulled to the end, this invention further includes a tab 23. Tab 23 is melted on the end of cut 2011 of the bag and runs thru between two hermetic belts 211, 222. Corresponding engaging concave and convex edges 231, 232 are formed on its upper and lower end faces 231, 232 correspond to the rail 2210, 2220 of two hermetic belts 221, 222. The thickness of this tab 23 corresponds to the difference between the upper and lower entry holes of zipper head 24. Therefore, when the zipper head 24 is pulled to the end, rails 2210, 2220 of the hermetic belts 221, 222 separately engage with the concave-convex edges 231, 232 of the tab 23 at the front lip 24a of zipper head 24 so as to form a hermetic space (as shown in FIG. 6b).

Again, as shown in FIG. 7 and FIG. 8, because the corpse bag of this invention has large surface area when it is deployed, it is necessary to fold repeatedly during packing. In order to avoid deformation of rails 2210, 2220 of hermetic belts 221, 222 of corpse bag 20 because of folding, this invention is designed to have a protecting piece 223. This protecting piece 223 has a small thickness and is placed under the hermetic belts 221, 222 to prevent 221, 222 from being damaged when it is folded. In FIG. 7, the protecting piece 223 is sealed together with the lower piece of hermetic belt 222 and bag surface 201, while in FIG. 8, the protecting piece 223 is adhered to an outside the bottom face 202 of bag (bottom face 202 is opposite to the hermetic belts 221, 222). Both of these two cases have the same effect.

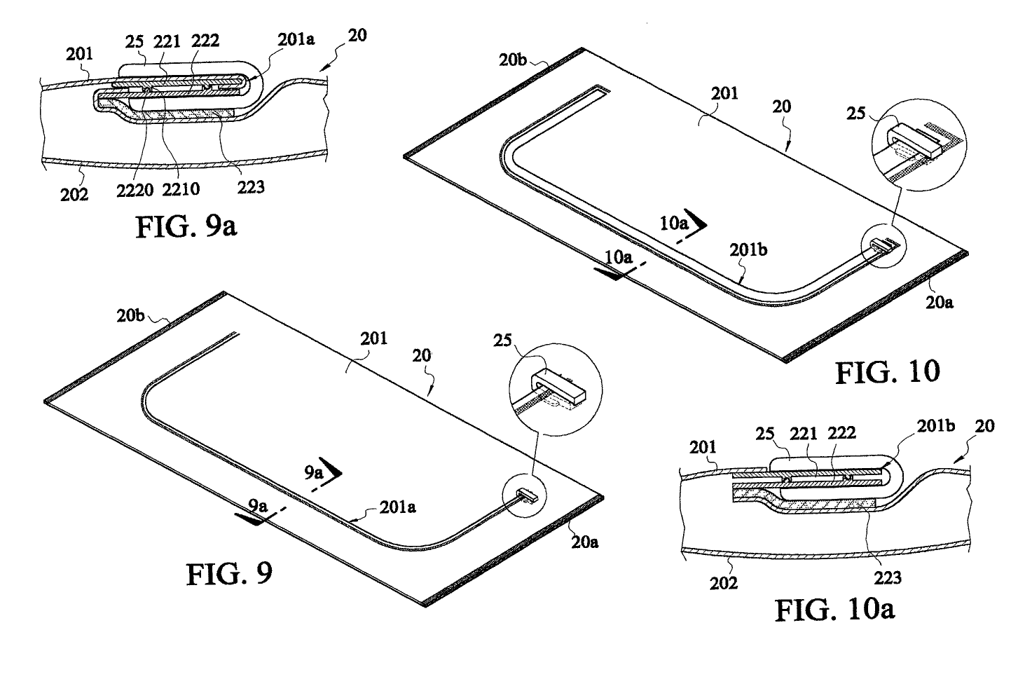

In addition, FIG. 9-9a are the embodiment of different sealing structure of corpse bag 20. It includes: a bag body, formed by bag-blowing machine, seal lines 20a, 20b which are formed on both sides separately, a cut which is formed on the surface 201, two hermetic belts 221, 222 and a protecting piece 223 which are thermally sealed separately on both side edges of the cut, two hermetic belts 221, 222 which form a folding layer 201 on the surface 201 of the bag and have rails 2210, 2220 (which can be fastened together), a U-shaped clamping ring 25 clamps on the folding layer 201a. The hermetic belts 221, 222 may be fastened together by sliding this U-shaped clamping ring 25. Thus, U-shaped clamping ring 25 is slid to the end of the cut so as to form a hermetic space.

FIG. 10-10a are an another variation of the embodiment. Its structure is substantially the same as that of above mentioned embodiment. The only difference is that: in FIG. 9-9a, the folding layer 201a, formed by the hermetic belts 221, 222, is covered with the bag surface 201 while in FIG. 10-10a, the folding layer 201b, formed by hermetic belts 221, 222, is not covered with the bag surface 201.

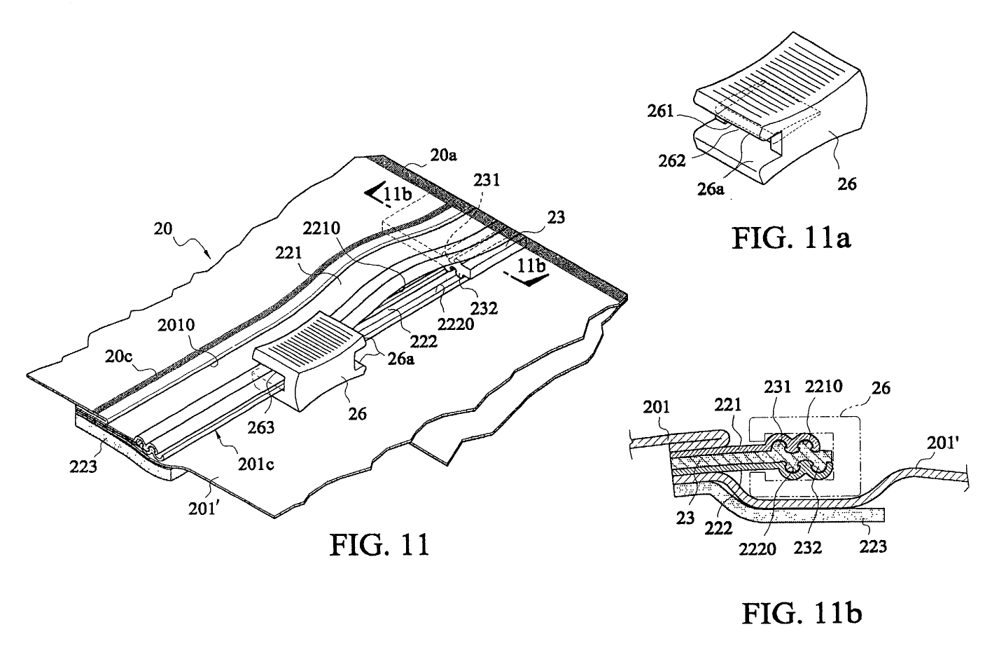

In addition, FIGS. 11-11b are an another structural embodiment of zipper head 26 (which is applied on the corpse bag 20) of this invention. As shown in FIG. 11, two overlapped engaging hermetic belts 221, 222 are thermofusibly sealed separately on the two side edges of the cut 2010 of bag body; and a folding layer 201c is formed on the bag surface 201. Protruding lip edges 26a are formed separately on the upper and lower walls in front of the improved zipper head 26. Two entry holes 261 are formed on the inner side of such a lip edge 26a. An exit hole 263 is positioned on the other end. Two hermetic belts 221, 222 enter separately thru the upper and lower entry holes 261, 262 of zipper head 26. After engaging, they exit thru the exit hole 263. Therefore, a V-shaped opening is also shaped in front of the zipper head 26 (as shown in FIG. 11). In order not to form a dead angle so as to be engaged when the zipper head 26 slides to the end, a tab 23 is installed between the ends of two hermetic belts 221, 222 (tab 23 is the same as shown in FIG. 6). The thickness of the tab 23 is approximately equal to the height difference of two entry holes of zipper head 26. Therefore, when the zipper head 26 slides to the end, two hermetic belts 221, 222 and the tab 23 engage together between the lip edge 26a is front of the zipper head 26 (as shown in FIG. 11b) to form a hermetic space. In addition, when the hermetic belt 222 is fused with the surface piece 201′ of the body, a protecting piece 223 is also thermofusibly sealed under the surface piece 201′ to prevent hermetic belts 221, 222 from folding end damaging.

| | |
|---|---|
| 2 | bag-blowing machine |
| 3 | feeding device |
| 4 | knife device |
| 5 | slab device |
| 6 | sealing and cutting device |
| 7 | adhering device |
| 20 | corpse bag of this invention |
| 20′ | prototype bag |
| 21 | traditional zipper |
| 201 | surface |
| 202 | bottom face |
| 20a, 20b | seal line |
| 20c | fusionable bond line |
| 2010, 2011 | cut |
| 221, 222 | hermetic belt |
| 2210, 2220 | rail |
| 223 | protecting piece |
| 23 | tab |
| 231, 232 | concave and convex edge |
| 24 | zipper head |
| 24a | lip |
| 241 | high entry hole |
| 242 | low entry hole |
| 25 | clamping ring |
| 51 | roll |
| 51a | initial roll |
| 51b | finishing roll |
| 511a, 511a′; 511b, 511b′ | conical slope |
| 52 | slab |
| 53, 53′ | conflicting element |
| 54, 54′ | conflicting element |
| 201a, 201b, 201c | folding layer |
| 26 | zipper lead |
| 26a | lip edge |
| 261 | upper entry hole |
| 262 | lower entry hole |
| 263 | exit hole |

What is claimed is:

1. An apparatus for manufacturing one piece molding of corpse bag, includes:
a collecting device for collecting the pipe-shaped prototype bag 20′ into a reel and pull it from this reel;
a feeding device 3, 3′ for feeding the prototype bag 20′ with a predetermined length from the reel;
a slab device 5, which includes a slab 52 whose top is planar and many rolls 51 are provided under this slab, which rolls 51 are placed within the prototype bag 20′;
a positioning device which is under the slab 52, and which has many conflicting elements 53, 53′: 54, 54′ to confine the levels of front and rear ends as well as left and right of the slab device 5;
a knife device 4, which is situated above the slab device 5 and is used to cut periodically a cut 2011 on the prototype bag 20′ on slab 52 from the above, after forming the cut, the knife device 4 retracting to its original position and an adhesive device 7, which is situated behind the knife device 4 and adheres seals to the cut from above;
a sealing and cutting device 6, which is situated at a given position in front of the bag, is used to form two seal lines 20a, 20b, and is also to cut between these two sealing lines for separating the front bag.

2. The apparatus for manufacturing one piece molding of corpse bag according to claim 1, wherein the prototype bag 20′ which is continuously reeled into a reel is formed by bag-blowing machine 2, using blow molding method to blow molten polymer into a pipe-shape.

3. The apparatus for manufacturing one piece molding of corpse bag according to claim 1, wherein conical slopes 511a, 511a′; 511b, 511b′ are formed separately on the both sides of the initial roll 51a and finishing roll 51b of slab 52.

4. The apparatus for manufacturing one piece molding of corpse bag according to claim 1, wherein the positioning device includes the conflicting elements 53, 53′ which are separately abutting against the initial roll 51a and finishing roll 51b of slab 52, on the outside of the bottom face 202 of prototype bag 20′.

5. The apparatus for manufacturing one piece molding of corpse bag according to claim 3, wherein the positioning mechanism includes a pair of conflicting elements 54, 54′ which are separately abutting against the conical slopes 511a, 511a′; 511b, 511b′ which are situated on both sides of initial roll 51a and finishing roll 51b and on the outside of the bottom face 202 of prototype bag 20′.

6. The apparatus for manufacturing one piece molding of corpse bag according to claim 4, wherein the conflicting elements 53,53′ preferably are rolls.

7. The apparatus for manufacturing one piece molding of corpse bag according to claim 5, wherein the conflicting elements 54, 54′ preferably are rolling wheels

8. The apparatus for manufacturing one piece molding of corpse bag according to claim 1, wherein the adhering device 7 is a hot press while the sealing element is hermetic belts 221, 222.

9. The apparatus for manufacturing one piece molding of corpse bag according to claim 1, wherein the cut bas no width and a traditional zipper 21 is sewed on the cut 2010 by a sewing machine.

10. A corpse bag includes:
a seamless pipe-shaped bag, sealing lines 20a, 20b being formed separately on both sides of the bag, and a cut 2011 being formed on the external surface 201;
two hermetic belts 221, 222 which are fusion seamed separately on both side edges of the cut 2011, the hermetic belts 221, 222 being provided with (clamping) rails 2210, 2220 which can be fastened together;
a tab 23 which is formed on the end of cut 2011 of the bag and runs thru between hermetic belts 221 and 222;
concave and convex edges 231, 232 which are correspond to the rails 2210, 2220 of two hermetic belts, and are formed on its upper and lower parts;
a zipper head 24 having a protruding lip 24a on its front part, high and low entry holes 241, 242 being formed on planes of different height within lip 24a, and a common exit hole being formed on the same plane at behind;
two hermetic belts 221, 222 which are introduced in separately from the entry holes 241, 242 of the zipper head 24, so that they are fastened together on the same plane, and then runs out thru exit hole so that when the zipper head 24 is slid to the end of the cut 2011, the tab 23 and two hermetic belts 221, 222 engaging at the lip 24a of zipper head 24 so as to form a hermetic space.

11. The hermetic corpse bag 20 according to claim 10, wherein a protecting piece 223 is formed under the hermetic belts 221, 222 and melts together with the low piece of hermetic belt 222.

12. The hermetic corpse bag 20 according to claim 10, wherein a protecting piece 223 is formed under the hermetic belts 221, 222, this protecting piece 223 being adhered to bag's bottom face 202.

13. The hermetic corpse bag 20 according to claim 10, wherein two hermetic belts 211, 222 form a folding layer 201a on the surface 201 of the bag.

14. The hermetic corpse bag 20 according to claim 13, wherein a U-shaped clamping ring 25 is provided and is clamped on the folding layer 201a.

15. The hermetic corpse bag 20 according to claim 13, wherein a protecting piece 223 is formed under the folding layer 201a.

16. A hermetic belt construction, including:
two long hermetic belts 221, 222 on which there are separately provided with rails 2210, 2220 which correspondingly fasten each other,
zipper heads 24, 26, in front of which lips 24a, 26a are formed in front of such zipper head, higher and lower entry holes 241, 242; 261, 262 being formed on the planes of different height between the lips 24a, 26a, a common exit hole being formed on the same plane at its rear end,
a tab 23 which is installed between rails 2210, 2220 at the end of two hermetic belts 221, 222, correspondingly engaging concave and convex edges 231, 232 being formed on the upper and lower end faces, separately corresponding to the rails 2210, 2220,
two hermetic belts 221, 222 which are separately introduced in thru the upper and the lower entry holes 241, 242 of zipper head 24, and after they engaged on the same plane, they exit thru the exist hole so that when the zipper head 24 slid to the end, tab 23 as well as two hermetic belts 221, 222 engage between the lip 24a of zipper head 24 to form hermeticity.
